(19) United States
(12) Patent Application Publication
(10) Pub. No.: US 2021/0110338 A1
(43) Pub. Date: Apr. 15, 2021

(54) System for Monitoring Petroleum Shipping

(71) Applicant: Nautical Control Solutions, LP, Spring, TX (US)

(72) Inventors: Anthony George, The Woodlands, TX (US); Clinton Carr, Trnava (SK); Petra Benova, New York, NY (US)

(21) Appl. No.: 17/067,147

(22) Filed: Oct. 9, 2020

Related U.S. Application Data
(60) Provisional application No. 62/913,447, filed on Oct. 10, 2019.

(51) Int. Cl. G06Q 10/08; G06F 16/9035; G06F 16/9038; H04L 9/06

(52) U.S. Cl. CPC G06Q 10/0831; G06Q 10/0832; G06Q 10/0833; H04L 2209/38; G06F 16/9035; G06F 16/9038; H04L 9/0643; G06Q 10/0835

(57) ABSTRACT

Systems and methods for monitoring complex transactions, such as international physical oil and petroleum trading and shipping transactions are disclosed. The disclosed systems include equipment installed on a vessel, such as a tanker, configured to monitor the quality and quantity of oil loaded onto and discharged from the vessel. The system also includes a remote data center configured to receive the cargo information from the vessel-board equipment. The remote data center is also configured to securely maintain information and documents generated during the transaction, such as financial documents, quality and quantity reports, bills of lading, and the like. The system provides a portal whereby stakeholders in the transaction can monitor all aspects of the transaction.

### CROSS REFERENCE TO RELATED APPLICATIONS

This is a non-provisional application of U.S. Provisional Patent Application Ser. No. 62/913,447, filed Oct. 10, 2019, which is incorporated herein by reference, and to which priority is claimed.

### FIELD OF THE INVENTION

The present application relates to systems and methods for monitoring and verifying international petroleum transactions, and the shipping of physical liquid cargoes.

### INTRODUCTION

Complex transactions, such as international petroleum trading and shipping transactions involve multiple stakeholders and involve sums that are in the millions of dollars. Various aspects of the transactions are performed by different parties, each of which require assurances from the other stakeholders throughout the transaction. These assurances are typically in the form of documents that are generated during various stages of the execution of the transaction. However, due to the number of stakeholders and the amounts of money involved, the potential of loss and/or fraud is prevalent. Documents may be incorrectly filled out or forged. The amount and/or quality of the cargo (i.e., petroleum) may be incorrect or the cargo may be surreptitiously offloaded before reaching its destination or simply not loaded at all. Stakeholders, such as insurers and financiers must account for risks of such loss and/or fraud, thereby increasing the transaction costs (i.e., interest rates, premiums, etc.).

Accordingly, there is a need in the art for methods and systems for facilitating such trading and shipping transactions, which provide transparency and accountability for all of the parties involved.

### SUMMARY

Disclosed herein is a system for monitoring and verifying a liquid petroleum cargo during shipping of the physical cargo in a vessel pursuant to a petroleum trading and shipping transaction, wherein the vessel comprises a cargo tank configured to hold the cargo and a transfer line configured to deliver the cargo to and from the cargo tank, the system comprising: one or more cargo meters configured to engage the transfer line and measure a first set of parameters comprising one or more of a mass flow, density, temperature, and viscosity of the cargo as the cargo is transferred through the transfer line to the cargo tank, a first server on the vessel configured to receive the measured first set of parameters, and a telemetry unit configured to transmit the first set of parameters, via satellite, from the first server to a remote data center. According to some embodiments, the remote data center comprises: one or more databases configured to receive and maintain the first set of parameters and data associated with one or more documents relating to the transaction, and a second one or more servers configured to: associate the first set of parameters with the data, and provide a portal, configured to allow a user to access the first set of parameters and the data. According to some embodiments, the one or more cargo meters comprise mass flow meters. According to some embodiments, the one or more cargo meters comprise Coriolis meters. According to some embodiments, the system further comprises one or more tank meters configured to engage the cargo tank and measure one or more of a density of the cargo, a volume of the cargo, and a level of the cargo. According to some embodiments, the one or more documents relating to the transaction comprises a letter of credit. According to some embodiments, either the first server or the second one or more servers are configured to generate a quantity and quality (Q & Q) report based on the first set of parameters. According to some embodiments, the second one or more servers is configured to associate the Q & Q report with a letter of credit related to the petroleum trading and shipping transaction. According to some embodiments, the portal is further configured to allow the user to enter the data into the one or more databases. According to some embodiments, the second one or more servers are further configured to integrate the data in the one or more databases into a post-trade management blockchain. According to some embodiments, the one or more cargo meters are further configured to measure a second set of parameters comprising one or more of a mass flow, density, temperature, and viscosity of the cargo as the cargo is transferred through the transfer line from the cargo tank, wherein the first server is configured to receive the measured second set of parameters, and wherein the telemetry unit is configured to transmit the second set of parameters, via satellite, from the first server to the remote data center. According to some embodiments, the one or more databases are configured to receive and maintain the second set of parameters and wherein the second one or more servers are configured to associate the second set of parameters with the data. According to some embodiments, either the first server or the second one or more servers are configured to generate a Q & Q report based on the second set of parameters. According to some embodiments, the one or more cargo meters are further configured to detect if cargo is discharged from the cargo tank, and wherein, upon such detection, the first server is configured to cause the telemetry unit to transmit a discharge notice to the data center, and wherein the second one or more servers are configured to issue the discharge notice to one or more users. According to some embodiments, the system further comprises a global positioning system (GPS) on the vessel, wherein the first server is configured to cause the telemetry unit to transmit GPS information from the vessel to the data center, and wherein the second one or more servers are configured to make the GPS information available via the portal. According to some embodiments, the system further comprises one or more security cameras on the vessel configured to capture video images on the vessel, wherein the first server is configured to cause the telemetry unit to transmit the video images to the data center, and wherein the second one or more servers are configured to make the video image available via the portal. According to some embodiments, the system further comprises fuel meters installed on an input supply line, an output supply line, and a transfer line of a fuel tank the vessel, wherein the fuel meters are configured to detect a difference in an amount of fuel transferred from the fuel tank and an amount of fuel burned by the vessel's engine, wherein the first server is configured to cause the telemetry unit to transmit an indication of the difference to the data center, and wherein the second one or more servers are configured to make the indication of the difference available via the portal.

### BRIEF DESCRIPTION OF THE DRAWINGS

FIG. 1 shows various stakeholders of an oil trading and shipping transaction.

FIG. 2 shows exemplary steps of an international physical oil/petroleum trading and shipping transaction and examples of documents and information generated at each of the steps.

FIG. 3 shows a system for monitoring and verifying an oil shipping transaction.

FIG. 4 shows a post-trade management blockchain.

### DESCRIPTION

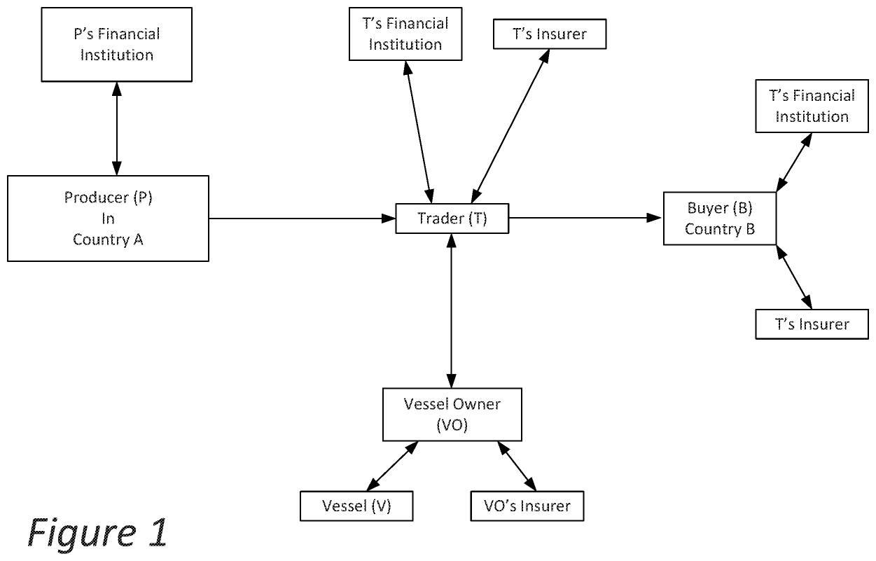

FIG. 1 illustrates the stakeholders involved in an example of a typical international physical oil/petroleum transaction. The illustrated example includes a producer (P), which may be, for example a state-owned producer in a country A. The producer will have a relationship with a financial institution, which will be involved with (and have a stake in) the transaction or act through the Central Bank of country A. The producer may arrange to sell its product to a trader (T) or to a buyer (B) (with the trader as an intermediary, for example). Both the trader and buyer will each have relationships with their own financial institutions and insurers, each of which will be involved with (and have a stake in) the transaction. In the illustrated transaction, it is the trader's responsibility to arrange shipping of the product, though in a situation where the buyer purchases directly from the producer it will be the buyer's responsibility to arrange shipping. Thus, the trader will arrange for shipment with a vessel owner (VO). The vessel owner will oversee the operation of a vessel (V) and will have its own insurer. Various of the parties involved in the transaction may have an interest in the vessel's performance, for example, the vessel's fuel usage, its location, and whether it conforms to relevant emissions standards, and the like.

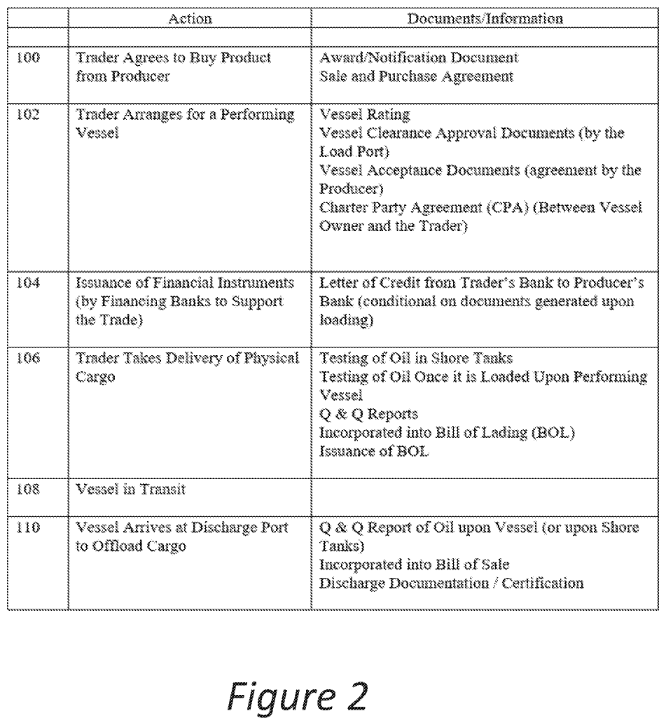

FIG. 2 illustrates various stages of an international physical oil/petroleum trading and shipping transaction and the various documents and information that is generated at each stage. At step 100, the trader agrees to buy oil form the producer. For example, assume that the producer P is a state-owned oil producer in a country of origin (Country A) and sells its crude oil production in cargo lots of 600,000 barrels on a monthly tender bid process. Assume that the trader T is the highest bidder and is scheduled to receive delivery of 600,000 barrels of oil from the producer at a load port in the Country A for loading during a certain date range. The producer will issue the trader with an official award notification/document. The trader and the producer will subsequently enter into a sale and purchase agreement summarizing the commercial terms of the transaction.

At step 102, the trader must arrange for shipping of the oil. Within a given period of time before the date at which the producer is to deliver the oil to the trader, the trader must nominate a performing vessel V to transport the oil and the producer may approve the vessel. The trader (or other parties to the transaction) may require evidence of a vessel rating for the vessel, which evidences the vessel's compliance with security, emissions standards, age of vessel and the like. The vessel V must be cleared by the load port, generating port clearance approval documents. Upon the producer P notifying the trader T that the performing vessel V is acceptable, the trader T confirms the vessel V to perform the loading at the designated port within the designated loading date range. The trader and the vessel owner enter into a Charter Party Agreement (CPA), which is a contract for the trader to hire the services of the vessel.

At step 104, following the execution of the sale and purchase agreement between the producer and the trader the trader's bank issues a letter of credit to the producer's bank. The letter of credit will be conditional upon certain documents that will be generated during the loading process, including but not limited to original shipping documents (Bills of Lading), quality and quantity (Q & Q) reports for the loaded oil, cargo load assessment, and certificate of origin. The producer and the trader appoint a mutually agreed independent inspector to assess the quality and quantity (Q&Q) of the oil held in the shore storage tanks at the load port.

At step 106, the performing vessel calls at the port of loading to take delivery of the oil. Before taking delivery, the oil in the shore tanks is assessed. Typically, the inspector will draw a five-gallon sample from the shore tanks. The sample is sealed and stored for a specified period of time in case of any quality disputes arise between the parties. Once the oil is loaded onto the vessel the inspector will confirm the amount of oil loaded and will take another sample from the vessel's cargo tanks. The inspector will also measure the quality of the oil, which involves assessing the specification of the loaded quantity in comparison to the typical specification or normal export quality of the particular grade of oil produced by the producer. This process also includes the assessment of both sediment and water content in the oil. The inspector's quantity and quality (Q & Q) report is incorporated into the vessel's bill of lading. In current practice, the Q & Q determination is largely performed manually. Again, a sample of the loaded oil may be drawn, sealed, and stored for future reference.

It is important to note here that these measurements at the time of loading are very important to the various stakeholders in the transaction. For example, the Q & Q report (and associated measurements) is a basis of the letter of credit whereby the trader's financer finances the transaction. The financer has a collateral interest in the physical cargo and is thus very interested in these measurements being accurate. But in current practice, these measurements are performed using crude manual methods. As explained below, the disclosed systems improve the measurements of the physical cargo (i.e., the oil that is loaded onto the ship), and thus provide the financer increased visibility into their collateral. Also, the use of the cargo as collateral to obtain financing is an area with the potential for fraud. Recently there have been instances of unscrupulous traders using the same cargo to secure multiple loans or means of financing from separate banks. Presently, there is no good solution to allow a potential financer to determine if a particular cargo has already been pledged as collateral to another bank. But the disclosed system addresses that problem.

Referring again to FIG. 2, upon completion of the loading and assessment process the vessel sails toward the discharge port (Step 108). At step 110, the vessel arrives at the destination or discharge port to offload the cargo. At the discharge port an inspector appointed by the buyer B inspects the Q & Q of the oil onboard the vessel. The Q & Q report at the discharge port is incorporated into the final sale documents between the buyer and the trader. Any discrepancies between the Q & Q determinations made at the loading and discharge ports may result in claims against the trader or the trader's insurer. Such disputes may also implicate the vessel owner VO and/or VO's insurer.

Notice that all of the stakeholders in the transaction have an interest in the accuracy and the timeliness of the inspections of the crude oil at the load port and the discharge port. For example, the letter of credit from the trader's bank and the producer's bank is contingent on the loading documents, including the Q & Q report generated at the loading port. Likewise, the sales contract between the buyer and the trader is contingent on the Q & Q report at the discharge port. The various insurers have an interest in those reports being consistent with each other, though under current practice the Q & Q evaluations are performed by different parties throughout the trade flow and with little transparency and accountability.

Also appreciate that the stakeholders to the transaction each have an interest in the operation, performance and/or the location of the vessel V at any given time. For example, the trader, the producer, and the buyer would benefit from knowing the location of the vessel and when it is likely to arrive at the respective ports. The financing bank and other stakeholders to the transaction would benefit from the ability to have real time insight that the loading of the vessel is proceeding as scheduled and in line with the parameters set out in the financial instrumentation. The trader, the financing banks and the end users would benefit from the ability to monitor loading and discharge of oil cargoes in real time with the ability to have insight of the cargoes Q & Q during and upon completion of the loading process. The trader, the financing bank and the insurer will benefit by having the ability to monitor the vessel's cargo tanks in real-time throughout the vessel's voyage. The parties would also like to be assured that the vessel does not load or unload oil at a sanctioned country, or otherwise unload the oil without authorization. The trader is interested to know that the vessel is operating in the most fuel-efficient manner possible so as to manage shipping costs. All parties would also like to know that the vessel complies with relative regulations, such as emissions regulations (for example, IMO 2020 and MRV regulations), fuel efficiency standards, and the like.

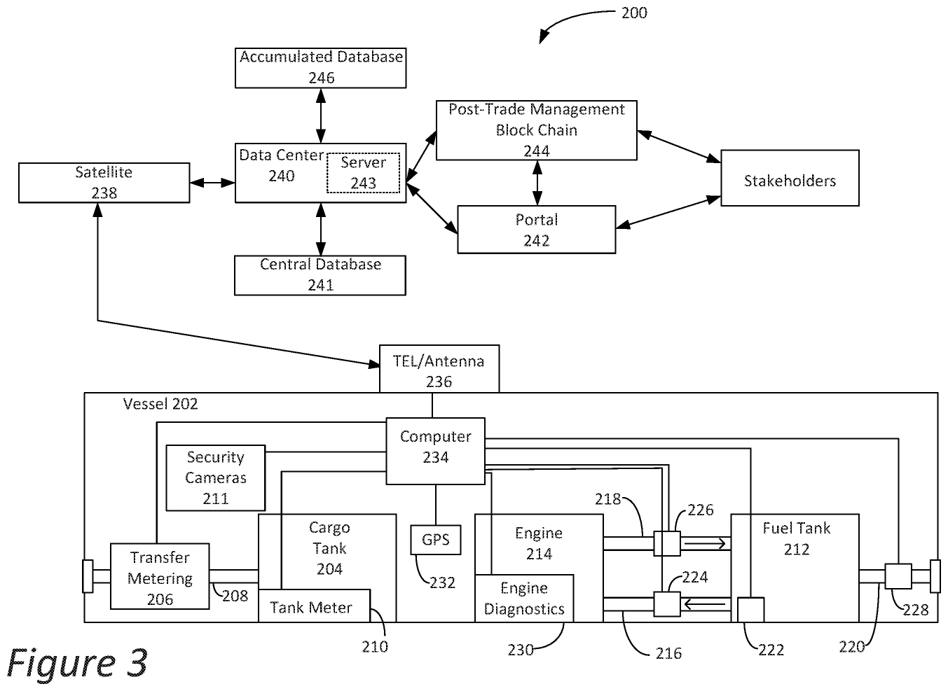

The disclosed methods and systems provide transparency into all of these aspects of the transaction. FIG. 3 illustrates an embodiment of a system 200 for providing a closed-loop monitoring and accountability of a petroleum shipping transaction, as described above. The system comprises components configured within a vessel 202. The vessel comprises one or more cargo tanks 204, for example, configured to contain oil. Transfer metering equipment 206 is installed on the transfer line 208 of the cargo tank and configured to monitor the oil transferred to/from the cargo tank.

According to some embodiments the transfer metering equipment 206 comprises one or more mass flow meters. According to some embodiments, the mass flow meter is a Coriolis meter or similar, which may be configured to measure the mass flow, volume flow, density and temperature of the oil transferred to/from the cargo tank. The transfer metering equipment 206 may also be configured to measure the viscosity of the oil transferred to/from the cargo tank. It should be appreciated that other types of metering equipment, such as ultrasonic meters, may be used.

The cargo tank 204 may be configured with one or more tank meters 210 configured to determine the amount of oil contained within the cargo tank. The tank meter(s) 210 may be crosschecked with the transfer metering equipment 206. For example, the density of the oil going into the tank may be provided to a differential pressure sensor in the tank so that the correct volume in the tank may be calculated. Additionally (or alternatively) one or more tank level sensors may be used. The transfer metering equipment 206 and the tank meter(s) 210 provide an accurate determination of the quantity and quality (Q & Q) of the oil loaded into and discharged from the cargo tank(s) 204.

The vessel 202 may also be equipped with one or more security cameras 211 configured to monitor (i.e., capture video images of) aspects of the operation of the vessel, and in particular, configured to monitor and record the onloading and offloading of the oil. The security cameras may be equipped with night vision capabilities. The security cameras provide a further layer of security and transparency into the cargo loading and transport process. In other words, stakeholders can observe (either in real time or via playback of recorded video data) the loading of the cargo, the security of the cargo throughout the voyage, and the offloading of the cargo.

The vessel 202 also comprises a fuel tank (a.k.a. fuel bunker) 212 configured to hold fuel for operating the vessel and an engine system 214 for driving the propellers and generators of the vessel 202. A fuel input supply line 216 interfaces with the input-side of the engine 214 and the fuel tank and supplies fuel from the fuel tank to the engine. A fuel output supply line 218 interfaces with the output side of the engine and the fuel tank to direct unconsumed or unburned fuel from the engine to the fuel tank. The vessel also includes a fuel transfer line 220 for transferring fuel into the fuel tank 212 and for transferring fuel from the fuel tank to a remote location from the vessel. A fuel sensor 222 may be configured to operatively engage the fuel tank 212 to measure the amount of fuel contained within the fuel tank.

Fuel metering equipment, such as mass flow meters 224, 226, and 228 may be installed on the fuel input supply line 216, fuel output supply line 218, and fuel transfer line 220, respectively. The mass flow meters 224, 226, and 228 may be Coriolis meters, for example, and may be configured to measure the mass flow, volume flow, density and temperature of the fuel transferred thru the respective lines. The mass flow meters 224, 226, and 228 (in conjunction with the fuel sensor 222, according to some embodiments) may be configured to provide fuel accountability between the amount of fuel transferred to/from the fuel tank 212 and the fuel burned by the engine 214. It should be appreciated that other types of fuel metering equipment, such as ultrasonic metering equipment may be used instead (or in addition to) the mass flow meters. Methods and systems for providing fuel measurement and accountability are described in U.S. Pat. No. 7,024,317, issued Apr. 4, 2006, the entire contents of which are hereby incorporated herein by reference. Thus, the fuel accountability aspects of the system 200 are not discussed in detail here. As also discussed in the incorporated U.S. Pat. No. 7,024,317, information provided by the sensors can be used to calculate burn rate and inform decisions concerning optimizing operating conditions, for example, to maximize fuel economy.

The vessel 202 may be equipped with one or more engine diagnostics systems 230 operatively engaged with the engine 214. The engine diagnostics system(s) 230 may monitor various aspects of engine performance and operation. For example, the engine diagnostics system(s) 230 may monitor emissions and emissions control systems of the engine 214. The vessel 202 is also equipped with a global positioning system (GPS) 232.

Data from the various meters, diagnostics equipment, cameras, and GPS may be provided to a computer 234. The data may be transferred via data transfer lines, such as fiber optic cabling, for example, or via wireless data transfer. A single computer 234 is illustrated for simplicity, but it should be appreciated that the computer 234 may comprise multiple networked components, which are collectively referred to as the computer 234. For example, the computer 234 may comprise components distributed within the engine room, cargo area, and wheelhouse of the vessel 202.

The computer may comprise one or more laptop or desktop computer components and one or more server components, for example, configured as electronics units located in stainless steel electronics boxes. The computer 234 may comprise personal computer, mid-range computer, or mainframe computer components. Some or all of the computer components can include a display or monitor such as a HMI, CRT, LCD, or other monitor screen. The computer may comprise one or more storage devices, such as hard drives including a database to store information and a memory in which computer programs are embodied. The computer components can also include user interfaces such as a keyboard, mouse, data collection, touchscreen, graphical display, or other devices, with which information and data are transferred to and from the computer components and the user. Other output devices can also be included such as printers, facsimile machines, and other such devices as understood by those skilled in the art.

According to some embodiments, the computer 234 comprises a server component and a client component. The client component and the server component of the computer may include a central processing unit (CPU), a read-only memory (ROM), and a random-access memory (RAM), as understood by those skilled in the art. The computer components can also comprise a stand-alone system or part of a network such as a local-area-network (LAN) or a wide-area-network (WAN). The client component can be interconnected among each other via a global communication network such as the Internet, or a local communication Intranet network accessible only within a particular organization. According to some embodiments, because the client component is located in the wheelhouse of the ship and the server component is located in the engine room of the ship and/or the cargo area, the client component is interconnected with the server component via a fiber-optic cable running from the engine room to the wheelhouse. Once the computer 234 is programmed to perform particular functions pursuant to instructions from program software that implements the functionality or method of this disclosure, such computer systems in effect become special-purpose computer systems particular to the functionality or method of this disclosure. The techniques necessary for this are well known to those skilled in the art of computer systems.

In addition, computer programs implementing the functionality or method of this disclosure will commonly be distributed to users on a distribution medium, such as floppy disk, CD-ROM, via wireless download from a storage medium on a server, or other computer-readable medium. The term “computer-readable medium” encompasses distribution media, intermediate storage media, execution memory of a computer, and any other medium or device capable of storing a computer program implementing the functionality or method of the disclosure for later reading by a computer system. The computer program will often be copied from the computer-readable medium to a hard disk or a similar intermediate storage medium. When the programs are to be run, they will be loaded either from their distribution medium or their intermediate storage medium into the execution memory of the computer, configuring the computer to act in accordance with the functionality or method of this disclosure. All such operations are well known to those skilled in the art of computer systems.

Various software modules can be used within the computer 234 in the embodiments of the disclosed methods. The client component may have client software stored thereon that preferably includes software modules such as a client graphical user interface (GUI), a data generator, a data requester, a secure client connector, and a database of information and memory, each of which is understood by those skilled in the art. The data requester requests data from a user, and the data generator compiles the information into the database, which stores the information. The client component GUI provides a visually pleasing graphical user interface on a monitor to facilitate the input and output of data by a user who is using the client software within the client component. The secure client connector establishes a private communication session between the client component and the server component.

The server component can include software modules such as a secure server connector, a client confirmer, a security component, a data mover, and a transmission confirmer. The secure server connector allows the client component to communicate with the server component while keeping the nature of the communications private. The client confirmer and the security component confirm the identity of the client component, and effectively detect the specific user accessing the server database at a particular point in time. The data mover receives data from the client component and transmits data between the client component and the server component. The transmission confirmer can verify that particular information in the database has been transmitted to the client component.

The databases within the client component and server component(s) can contain independent blocks of information. For example, one sub-database can include data relating to the fuel measurement and accountability process, and another sub-database can include data relating to the fuel economy and optimization process, another sub-database may include data relating to the Q & Q of the oil transferred to/from, and contained within the cargo tank. In addition, the computer components can each have an independent memory to contain unique computer programs. For example, one sub-memory can contain computer programs relating to the fuel measurement and accountability process, and another sub-memory can include computer programs relating to the fuel economy and optimization process, and another sub-memory can include computer programs relating to monitoring the cargo. Other sub-memories may be configured for processing and storing video data obtained from the security cameras.

The computer 234 may be operatively connected with a telemetry unit 236, including appropriate modules and antenna(s) configured to transmit/receive information to a remote location. For example, the telemetry unit may be configured for communicating via a satellite network 238, such as an IRIDIUM satellite data communication network. The data and information obtained from the various metering and monitoring equipment on the vessel 202 may be transmitted, via satellite to a data center 240. The data center 240 may comprise one or more computers configured to process the various data obtained from the vessel. Generally, the data center computer(s) may include the various computer components as described above with reference to the computer 234, but in a data center environment. For example, the data center may include one or more servers, processors, data bases, computer-readable media, memories, and the like. For example, the data center 240 may comprise at least one server 243 configured to execute the functionality described below, for example, by executing programming code stored on non-transitory computer-readable media such as one or more disc drives, ROM, or the like. The server 243 may include a central processing unit (CPU), a read-only memory (ROM), and a random-access memory (RAM), as understood by those skilled in the art.

According to some embodiments the data center 240 may include (or be associated with) one or more databases, such as a central database 241, which is configured to contain all of the information related to a particular transaction. For example, the central database may contain the various documents generated during the transaction, as described above in reference to FIG. 2. The documents may be integrated into a post-trade management blockchain, as described in more detail below. The central database 241 may also be configured to receive and store the data generated by the vessel-board metering and monitoring equipment described above, such as the data collected during loading, unloading, and transport. Thus, the central database can associate the various documents related to the transaction, such as the financial documents, with the physical cargo that is loaded onto the vessel and subsequently discharged from the vessel.

According to some embodiments, the data center 240 may be configured to present the information contained received by the data center 240 and/or contained in the central database 241 via a portal 242, which may be accessed by the stakeholders. For example, the various stakeholders may access the portal 242 via an internet connection. The stakeholders can also update the central database via the portal, for example, by inputting data points and submitting documents as they are generated throughout the transaction and associating those documents with the transaction. The data points/documents may be integrated into the post-trade management blockchain for authenticity purposes, as described below. According to some embodiments, the portal 242 may comprise a user interface, such as a GUI, whereby stakeholders (or other parties that have been granted access) may view information relating to the transaction.

By accessing the portal 242, the stakeholders have visibility into a plethora of information concerning the transaction. The stakeholders can see the underlying documents to the transaction, the confirmation that the vessel has taken delivery of the physical cargo recited in the underlying documents, and confirmation that the physical cargo has been delivered as expected. For example, assume that the trader has agreed to take delivery of a certain amount of oil from a producer. As explained above, the trader's bank will issue a letter of credit to the producer's bank conditional on the Q & Q documents generated upon loading, and the physical cargo will serve as the bank's collateral for the financing. Using the disclosed system, the financial institution can enter certain information pertaining to the letter of credit and transaction into the central database 241. The trader can insert certain information pertaining to the vessel that will perform the loading. When the cargo is loaded onto the vessel, the Q & Q information can be associated with the transaction. Thus, the central database will contain information reflecting that a certain amount of oil of a given quantity was loaded (or is to be loaded) onto a specific vessel (denoted by the name of the vessel and/or the vessel's registration number (IMO), for example) at a certain port (given by the location and/or GPS coordinates) at a certain time, and that the transaction is secured by a certain letter of credit (given by a reference number, for example) generated by a certain bank. According to some embodiments, parties other than the stakeholders may be granted access to this information. For example, financial institutions and insurers that work in the trading industry may be granted access. Using such access, potential stakeholder financers/insurers can confirm whether a given cargo has already been pledged as collateral and/or is already associated with a letter of credit. The ability of all of the stakeholders and potential stakeholders to view such associations of the underlying documents to the physical cargo trade can prevent fraud, such as the double (or multiple) financing schemes mentioned above.

Moreover, the stakeholders (e.g., the trader, producer, buyer, banks, insurers, and the like) can monitor real-time information throughout the entire duration of the transaction and shipping of the physical cargo. The stakeholders can monitor the position of the vessel as it enters the load port and can monitor the quality and quantity of oil that is loaded into the cargo tank(s) of the vessel, as determined by the transfer metering equipment 206. Once the oil is loaded, the stakeholders can confirm the amount of oil that is in the cargo tank(s) via the tank metering equipment 210. According to some embodiments, Q & Q reports may be automatically generated by the system and confirmed via the portal 242. The amount of oil in the cargo tank(s) may be continually monitored throughout the vessel's voyage to confirm that the cargo has not been discharged without the consent of shareholders (such as the financing bank). In the event of a discharge, the system may notify the shareholders, for example, by an email and/or SMS message notification. Likewise, the vessel's position, the vessel's performance (such as fuel consumption, fuel efficiency, emissions compliance, and the like) may be monitored throughout the voyage. Upon arrival at the discharge port, the stakeholders can monitor the quality and quantity of the oil as it is discharged from the vessel. Since the same monitoring equipment is used for loading and unloading, the measurements should be consistent. In sum, access to the portal 242 provides stakeholders with extreme real-time transparency into the loading, shipping, and unloading process. Such transparency provides reduced uncertainties and reduced transaction costs throughout the process.

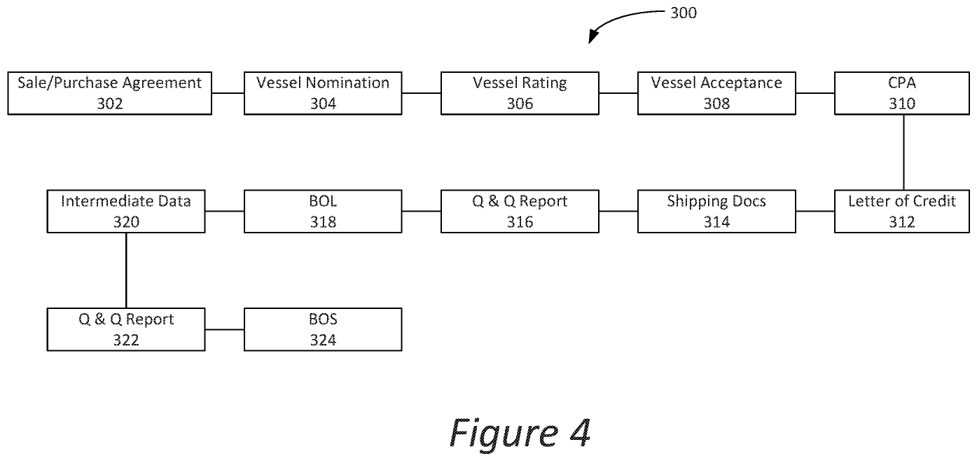

Data from the portal 242, the data center 240, and the central database 241 may be integrated into a post-trade management blockchain 244. Post-trade management blockchain environments are known in the art and are not discussed here in detail. Briefly, the post-trade blockchain is a distributed ledger of transactions accessible by the stakeholders. New transactions are added to the blockchain as blocks linked to the previous block in the chain via cryptographic algorithms. Approval by a majority of parties is generally needed to add transactions to the blockchain or to verify ownership. FIG. 4 illustrates some aspects of a blockchain 300 relevant to transactions as described herein. The blockchain may include blocks evidencing the sale and purchase agreement between the producer and the trader 302, the nomination of a performing vessel 304, a rating of the vessel's compliance with emissions/efficiencies standards (e.g., provided by the vessel owner) 306, vessel approval to dock in the loading port 308, the charter party agreement between the trader and vessel owner 310, and the letter of credit between the trader's, producer's and end users banks. Upon the vessel docking at the load port and commencing loading, blocks may be added to the blockchain, such as various original shipping documents 314 (load assessment, certificate of origin, etc.), Q & Q report 316, and bill of lading 318. According to some embodiments, the system may automatically generate the Q & Q report 316 and add it to the blockchain 300. The blockchain 300 may be further update after the vessel leaves the loading port. For example, intermediate monitoring data 320 may be periodically uploaded. For example, the system may periodically monitor the amount of oil in the tank throughout the voyage and/or monitor the vessel's performance and update the blockchain 300 accordingly. Upon arrival at the discharge port the blockchain 300 may be updated with additional blocks, such as a Q & Q report 322 upon discharge of the oil and a bill of sale 324 for the oil, etc. Again, according to some embodiments, the system may automatically generate the Q & Q report 322 and update the blockchain. It should be appreciated that the blockchain 300 is only an example, and other embodiments of applicable blockchains may include additional blocks or fewer blocks.

It will be appreciated that the disclosed methods and systems provide transparency for all stakeholders in a petroleum trading and shipping operation. It should also be appreciated that the methods and systems can accumulate data that, over numerous transactions, becomes statistically significant. Referring again to FIG. 3, information obtained, for example, via the data center 240, can be accumulated in one or more accumulation databases 246 for numerous transactions. The accumulated data comprises a plethora of information related to commodities trading, wherein each piece of data is obtained via direct and verifiable measurement. For each accumulated transaction, the data may include the buyer, the seller, the trader, the vessel, the loading port, the discharge port, the price of the cargo, the amount of cargo, and like. Analytics can be applied to such data to determine strategic information about global commodities movements, pricing, etc.

It should also be appreciated that, while the disclosure has focused on the implementation of the methods and systems in the context of crude oil transactions and shipping, the disclosed methods and systems are applicable in other transactions. For example, they may be applied for any liquid cargo, for example, liquified natural gas (LNG), fuel oil, refined oil products, and the like.

The disclosed methods and systems have primarily been described in the context of a trading and shipping transaction and have primarily focused on aspects of the transaction that occur leading up to and after a trader (or buyer) has taken delivery of physical cargo. It should be appreciated that aspects of the disclosed methods and systems can also be used to facilitate the tender bid process for the sale of oil products through the integration with blockchain provided by the disclosed systems. As a standard industry practice, oil producers and/or producing countries typically offer their crude oil production for sale through a tender bid process, which is generally held on a monthly. Bid invitations are sent to registered/qualified purchasers. A deadline (date & time) for the submission of bids is set, and bids are submitted by participants, typically to a designated email address. Following the deadline, the bids are reviewed by a committee and the highest bidders are awarded the respective crude oil cargoes.

There are various discrepancies in this process given that certain traders may have strategically positioned informants that skew the tender bid process through dubious practices whereby bid price information is leaked prior to the tender submission cut off time, this allows the certain traders to use this information to their advantage to subsequently submit a slightly higher bid to win the cargo volumes. This process is known in the industry as “a last look.”

The disclosed systems comprising the integration of blockchain synchronized with a web-based portal can be used by producers or their respective marketing departments to host tender bids for the sale of their oil production in a secure, encrypted tamperproof environment to mitigate unfair industry practice. Traders, as well as financial and insurance institutions that work in the trading industry, who will have access to the web-based portal for the reasons explained above, may also use the secure portal to verify certain commercial aspects of transactions that they may be approached to finance.

While the invention herein disclosed has been described in terms of specific embodiments and applications thereof, numerous modifications and variations could be made thereto by those skilled in the art without departing from the scope of the invention set forth in the claims.

What is claimed is:

1. A system for monitoring and verifying a liquid petroleum cargo during shipping of the physical cargo in a vessel pursuant to a petroleum trading and shipping transaction, wherein the vessel comprises a cargo tank configured to hold the cargo and a transfer line configured to deliver the cargo to and from the cargo tank, the system comprising:
one or more cargo meters configured to engage the transfer line and measure a first set of parameters comprising one or more of a mass flow, density, temperature, and viscosity of the cargo as the cargo is transferred through the transfer line to the cargo tank,
a first server on the vessel configured to receive the measured first set of parameters, and
a telemetry unit configured to transmit the first set of parameters, via satellite, from the first server to a remote data center,
wherein the remote data center comprises:
one or more databases configured to receive and maintain the first set of parameters and data associated with one or more documents relating to the transaction, and
a second one or more servers configured to:
associate the first set of parameters with the data, and
provide a portal, configured to allow a user to access the first set of parameters and the data.

2. The system of claim 1, wherein the one or more cargo meters comprise mass flow meters.

3. The system of claim 1, wherein the one or more cargo meters comprise Coriolis meters.

4. The system of claim 1, further comprising one or more tank meters configured to engage the cargo tank and measure one or more of a density of the cargo, a volume of the cargo, and a level of the cargo.

5. The system of claim 1, wherein the one or more documents relating to the transaction comprises a letter of credit.

6. The system of claim 1, wherein either the first server or the second one or more servers are configured to generate a quantity and quality (Q & Q) report based on the first set of parameters.

7. The system of claim 6, wherein the second one or more servers is configured to associate the Q & Q report with a letter of credit related to the petroleum trading and shipping transaction.

8. The system of claim 1, wherein the portal is further configured to allow the user to enter the data into the one or more databases.

9. The system of claim 1, wherein the second one or more servers are further configured to integrate the data in the one or more databases into a post-trade management blockchain.

10. The system of claim 1, wherein the one or more cargo meters are further configured to measure a second set of parameters comprising one or more of a mass flow, density, temperature, and viscosity of the cargo as the cargo is transferred through the transfer line from the cargo tank, wherein the first server is configured to receive the measured second set of parameters, and wherein the telemetry unit is configured to transmit the second set of parameters, via satellite, from the first server to the remote data center.

11. The system of claim 10, wherein the one or more databases are configured to receive and maintain the second set of parameters and wherein the second one or more servers are configured to associate the second set of parameters with the data.

12. The system of claim 10, wherein either the first server or the second one or more servers are configured to generate a Q & Q report based on the second set of parameters.

13. The system of claim 1, wherein the one or more cargo meters are further configured to detect if cargo is discharged from the cargo tank, and wherein, upon such detection, the first server is configured to cause the telemetry unit to transmit a discharge notice to the data center, and wherein the second one or more servers are configured to issue the discharge notice to one or more users.

14. The system of claim 1, further comprising a global positioning system (GPS) on the vessel, wherein the first server is configured to cause the telemetry unit to transmit GPS information from the vessel to the data center, and wherein the second one or more servers are configured to make the GPS information available via the portal.

15. The system of claim 1, further comprising one or more security cameras on the vessel configured to capture video images on the vessel, wherein the first server is configured to cause the telemetry unit to transmit the video images to the data center, and wherein the second one or more servers are configured to make the video image available via the portal.

16. The system of claim 1, further comprising fuel meters installed on an input supply line, an output supply line, and a transfer line of a fuel tank the vessel, wherein the fuel meters are configured to detect a difference in an amount of fuel transferred from the fuel tank and an amount of fuel burned by the vessel's engine, wherein the first server is configured to cause the telemetry unit to transmit an indication of the difference to the data center, and wherein the second one or more servers are configured to make the indication of the difference available via the portal.
